(19) United States
(12) Patent Application Publication
(10) Pub. No.: US 2005/0289096 A1
(43) Pub. Date: Dec. 29, 2005

(54) Method, system and computer program to enable SIP event-based discovery of services and content within a community built on context information

(75) Inventors: Dirk Trossen, Cambridge, MA (US); Dana Pavel, Cambridge, MA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/874,945

(22) Filed: Jun. 23, 2004

(51) Int. Cl. G06F 7/00

(52) U.S. Cl. 707/1

(57) ABSTRACT

Disclosed is an event notification system and a method to operate an event notification system that has servers and a subscriber unit. The method includes sending a subscription request message from the subscriber unit to a discovery server, where the subscription request message includes a discovery query, and responsive to a receipt of the subscription request message, parsing the discovery query and accepting the subscription request if the discovery query is supportable by the discovery server. The method further includes formulating a context query based on the parsed discovery query and sending the context query to a context query server. The context query server parses the context query and returns in response identifications of a plurality of event servers that form a community of event servers that together determine a result of the discovery query. The discovery server subscribes to the availability of each of the event servers that form the community of event servers, and notifies the subscriber unit of available services that are discovered.

### CROSS-REFERENCE TO RELATED PATENT APPLICATIONS

This patent application is related to the following commonly assigned U.S. Patent Applications: D. Trossen, “Integration of Service Registration and Discovery in SIP Environments”, Ser. No. 10/179,244, filed Jun. 26, 2002; D. Trossen, “Content and Service Registration, Query, and Notification using SIP Event Packages”, Ser. No. 10/330,146, filed Dec. 30, 2002; D. Trossen, K. Mehta, “Access Control Alert Method using SIP Event Package”, Ser. No. 10/353,014, filed Jan. 29, 2003; D. Trossen, “Querying for SIP Event Packages by Using SIP OPTIONS Method or by Using Service Discovery”, Ser. No. 10/418,313, filed Apr. 18, 2003; D. Trossen, D. Pavel, “Application Semantic Binding through SIP Event Package Template”, Ser. No. 10/465,455, filed Jun. 19, 2003; and to U.S. patent application Ser. No. 10/______, filed on even date with this patent application, and entitled “Method, System and Computer Program to Enable Querying of Resources in a Certain Context by Definition of SIP Event Package”, by Dirk Trossen and Dana Pavel, the disclosures of which are incorporated by reference in their entireties.

### TECHNICAL FIELD

This invention relates generally to wireless communications systems and methods and, more specifically, relates to wireless terminals and wireless network nodes that use a Session Initiation Protocol (SIP).

### BACKGROUND

The infrastructure of the Session Initiation Protocol (SIP) is defined in IETF RFC3261 (Rosenberg et al., June 2002). In general, the SIP is an application-layer control (signaling) protocol for creating, modifying and terminating sessions with one or more participants. The sessions can include Internet telephone calls, multimedia distribution and multimedia conferences. SIP invitations used to create sessions carry session descriptions that allow participants to agree on a set of compatible media types. SIP makes use of elements called proxy servers to help route requests to the user's current location, authenticate and authorize users for services, implement provider call-routing policies and provide features to users. SIP also provides a registration function that allows users to upload their current locations for use by proxy servers. SIP runs on top of several different transport protocols.

In “SIP-Specific Event Notification”, A. Roach, RFC 3265, July 2002 (referred to hereafter simply as “RFC 3265”), there is described a SIP event framework to enable event-based information provisioning to any node in the Internet. This procedure is expected to become a key element within the SIP infrastructure. Examples of this kind of information are presence, location information, content/service availability, or access-controlled SIP events.

As is discussed in RFC 3265, the general concept is that entities in the network can subscribe to resource or call state for various resources or calls in the network, and those entities (or entities acting on their behalf) can send notifications when those states change. A typical flow of messages would be:

| Subscriber | Notifier |
|---|---|
| \|-----SUBSCRIBE---->\| | Request state subscription |
| \|<-------200--------------\| | Acknowledge subscription |
| \|<------NOTIFY---------\| | Return current state information |
| \|--------200------------->\| | Acknowledge |
| \|<------NOTIFY--------\| | Return current state information |
| \|--------200------------->\| | Acknowledge |

Subscriptions are expired and must be refreshed by subsequent SUBSCRIBE messages.

Several useful definitions include the following:

Event Package: An event package is an additional specification which defines a set of state information to be reported by a notifier to a subscriber. Event packages also define further syntax and semantics based on the framework defined by RFC 3265 that are required to convey such state information.

Event Template-Package: An event template-package is a special kind of event package which defines a set of states which may be applied to all possible event packages, including itself.

Notification: Notification is the act of a notifier sending a NOTIFY message to a subscriber to inform the subscriber of the state of a resource.

Notifier: A notifier is a user agent which generates NOTIFY requests for the purpose of notifying subscribers of the state of a resource. Notifiers typically also accept SUBSCRIBE requests to create subscriptions.

State Agent: A state agent is a notifier which publishes state information on behalf of a resource; in order to do so, it may need to gather such state information from multiple sources. State agents always have complete state information for the resource for which they are creating notifications.

Subscriber: A subscriber is a user agent which receives NOTIFY requests from notifiers; these NOTIFY requests contain information about the state of a resource in which the subscriber is interested. Subscribers typically also generate SUBSCRIBE requests and send them to notifiers to create subscriptions.

Subscription: A subscription is a set of application state associated with a dialog. This application state includes a pointer to the associated dialog, the event package name, and possibly an identification token. Event packages will define additional subscription state information. By definition, subscriptions exist in both a subscriber and a notifier.

Subscription Migration: Subscription migration is the act of moving a subscription from one notifier to another notifier.

The SUBSCRIBE method is used to request current state and state updates from a remote node.

J. Rosenberg has defined in “A Watcher Information Event Template-Package for the Session Initiation Protocol (SIP)”, draft-ietf-simple-winfo-package-05.txt, Jan. 31, 2003, a watcher information template-package for the SIP event framework. Watcher information in this context refers to a set of users that are subscribed to a particular resource within a particular event package. Watcher information changes dynamically as users subscribe, unsubscribe, are approved, or are rejected. A user can subscribe to this information, and therefore can learn of changes to this information. This particular event package is referred to as a template-package, as it can be applied to any event package, including itself.

As is well known, there are situations in which one is faced with the need to obtain appropriate information regarding a certain topic. It is often the case that one uses the knowledge of communities to perform such discovery. Newsgroups are classical examples for this technique in the Internet. By subscribing to particular topics one shares the dedicated community knowledge among the participants of the newsgroup. If one needs to find specific information related to the newsgroup topic, one might search the newsgroup's archive for appropriate information. In this type of scenario, knowledge of community-relevant context information (such as location, time and date, relation to other people and communication means at time of discovery) is believed to improve the identification and creation of such knowledge-based communities.

However, current SIP environments do not offer functionality for determining communities as described above, together with the functionality of discovering services or content within such community. Since SIP (events) are believed to have promise as enablers for future peer-to-peer (P2P) and other services, and as a technology in context provisioning, a method to provide a community of servers based on SIP would be desirable.

### SUMMARY OF THE PREFERRED EMBODIMENTS

The foregoing and other problems are overcome, and other advantages are realized, in accordance with the presently preferred embodiments of these teachings.

In one aspect this invention provides a method to operate an event notification system having servers and a subscriber unit. The method includes sending a subscription request message from the subscriber unit to a discovery server, where the subscription request message includes a discovery query, and responsive to a receipt of the subscription request message, parsing the discovery query and accepting the subscription request if the discovery query is supportable by the discovery server. The method further includes formulating a context query based on the parsed discovery query and sending the context query to a context query server. The context query server parses the context query and returns in response identifications of a plurality of event servers that form a community of event servers that together determine a result of the discovery query. The discovery server subscribes to the availability of resources at the event servers that form the community of event servers, and notifies the subscriber unit of available services that are discovered.

For a case where a lifetime of the subscription request message is non-zero the method further includes notifying the subscriber unit of a change in availability of a previously unavailable service provided by an event server of the community of event servers, and also notifying the subscriber unit of a change in membership of the community of event servers.

In a further aspect this invention provides an event notification system that operates in accordance with the foregoing method, as well as a subscriber unit, a discovery server, and a context query server that each operate in the event notification system in accordance with the foregoing method.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 shows the overall architecture and major logical entities of the present invention;

FIG. 2 illustrates various process steps and messages in accordance with the invention;

FIG. 3 shows a block diagram of the discovery server of FIG. 1; and

FIG. 4 shows a block diagram of the context query server of FIG. 1.

### DETAILED DESCRIPTION OF THE PREFERRED EMBODIMENTS

Remote service discovery relates to methods to find particular knowledge, services or content with particular constraints. In this approach discovery agent federations attempt to bring the notion of communities into remote service discovery by leveraging the federation's knowledge for particular discovery tasks. Such federations then typically exist for certain knowledge areas, i.e., representing a community of interest in the abovementioned sense.

By way of introduction, this invention grows out of a realization by the inventors that a solution for remote service discovery that would apply the knowledge of such highly context-based communities would be beneficial in creating a positive value proposition in this space. In this context, functionality for notifying applications upon the addition or deletion of relevant content or services is beneficial as well.

Exemplary discovery queries that are enabled by the use of this invention include, but certainly are not limited to:
a) “Discover a certain service among a set of people within a certain location and is also present.”
b) “Discover content among a set of people interested in a certain topic”.
c) “Notify me about available services within a certain location of providers that are present”.
d) “Notify me about new content among a set of people that is close to my own location”

With regard to the discovery query (a), “presence” can be construed as being, for example, defined in J. Rosenberg, “A Presence Event Package for the Session Initiation Protocol (SIP)”, Internet Draft, Internet Engineering Task Force, (work in progress), January 2003, for mobile devices.

The present invention provides a system and a method that permits discovery of content and services within a set of entities, which constitute a certain (context-based) community. The community building process is implemented through finding a set of people that creates a community through a common set of context information together with other information, such as preference or background-related information (such as, as non-limiting examples, “expert in a certain area” or “member of a certain group”).

The presently preferred embodiment of this invention describes the system and method in the overall context of the SIP event framework, as defined by RFC 3265. Hence, determination of the community, as well as the actual discovery, are based on SIP events. However, the use of the SIP event framework is not to be construed as a limitation upon the practice of this invention.

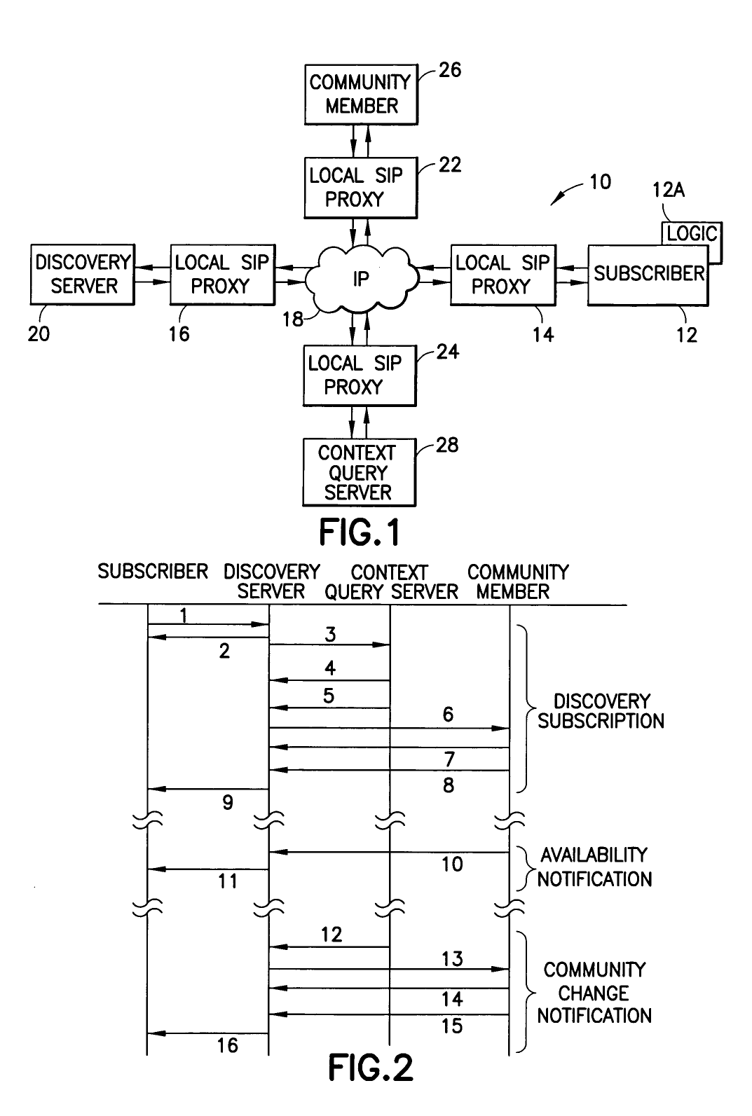

Referring to FIG. 1 there is shown a simplified architectural diagram of a system 10 that is suitable for practicing this invention. The system 10 includes a subscriber 12, local SIP proxies 14, 16, 22 and 24, a network such as an Internet Protocol (IP) network 18, a discovery server 20, community members that are shown as one instance of a community member 26, and a context query server 28.

In the presently preferred, but non-limiting embodiment of this invention the subscriber 12 is associated with a mobile wireless communications device, such as a cellular telephone, or a personal communicator, or a mobile user or agent such as a computer that is coupled to the network 18 via a wireless link. The network 18 can comprise the Internet.

The subscriber 12 includes logic 12A and is assumed to desire to subscribe to the availability of services or content within a certain community. The context query server 28 implements SIP events, compliant to RFC 3265, and thus functions as a SIP event server. As is shown as well in FIG. 3, in accordance with this invention the context query server 28 includes, apart from the functionality 28A compliant with RFC 3265, and an interface 28B to the network 18, via SIP proxy 24, the following functional units and modules.

The context query server 28 includes a module 28C that provides support for an event package that determines a set of resources (expressed as SIP URIs) based upon a certain given constraint. The context query server 28 includes a module 28D that provides support for content indirection methods, such as those defined in S. Olson, “Requirements for Content Indirection in Session Initiation Protocol”, IETF Draft, September 2002, or other methods for retrieving data from external sources (such as so-called ontology servers, not shown in FIG. 1). The context query server 28 includes logic 28E to interpret a query semantic provided through a subscription, and also includes logic 28F to implement the desired query semantic provided through the subscription. Such implementation typically operates on resource data 29 that resides on the context query server 28, although all or some of the resource data can be obtained externally. The resource data 29 associated with context-dependent constraints can include one or more of presence data, watcherinfo, call state and application-specific events. The context query server 28 includes an optional module 28G that provides support for (optional) authorization policies that can be implemented in order to preserve the privacy of the resource data 29, in accordance with J. Rosenberg, “The Extensible Markup Language (XML) Configuration Access Protocol (XCAP)”, Internet Draft, Internet Engineering Task Force, (work in progress), May 2003.

Commonly assigned U.S. patent application 10/______, filed on even date with this patent application, and entitled “Method, System and Computer Program to Enable Querying of Resources in a Certain Context by Definition of SIP Event Package”, by Dirk Trossen and Dana Pavel, provides a non-limiting example of a SIP event package that implements the desired functionality. Briefly, this commonly assigned U.S. Patent Application discloses a method and system that operates an event server, preferably a SIP event server, with a subscriber unit, such as the subscriber 12 of FIG. 1. The method includes formulating a query and sending a subscription request message to the event server, where the subscription request message contains the query. In response to a receipt of the subscription request message at the event server, logic parses the query and the subscription request is accepted if the query is successfully parsed and understood, and if appropriate resource data is available to the event server to determine a result of the query.

As was noted, this invention may make use of one or more ontology servers that allow for registering and the querying of ontologies. For the purposes of this invention ontologies can be considered to capture the semantics of information from various sources and to give them a concise, uniform and declarative description (see, for example, Y. Ding, D. Fensel, “Ontology Library Systems: The key to successful Ontology Re-use”, http://www.semanticweb.org/SWWS/program/full/paper58.pdf, August 2001).

With respect to the notion of communities in accordance with this invention, it is the context query server 28 that implements the functionality to determine the community based on the query input in the availability request received from the subscriber 12. Hence, the community building process takes place within the context query server 28 through appropriate data processing and data mining functionality.

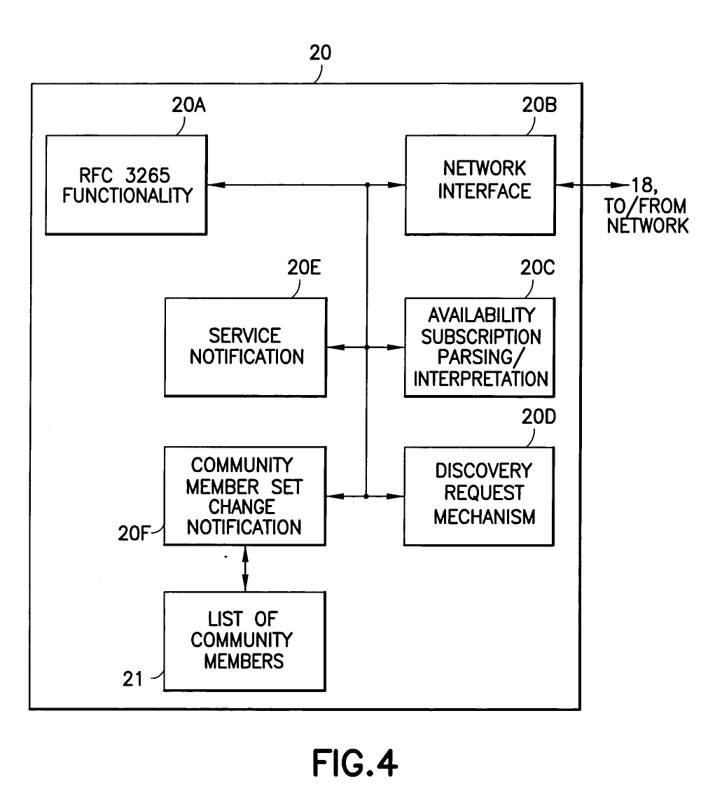

As is shown as well in FIG. 4, in accordance with this invention the discovery server 20 implements SIP events and includes, apart from functionality 20A compliant with RFC 3265, and an interface 20B to the network 18, via SIP proxy 16, the following functional units and modules. The discovery server 20 includes logic 20C to interpret the given availability subscription of the subscriber 12. The logic 20C determines the context-dependent part of the query in order to issue an appropriate context query to the context query server 28, as described below. The discovery server 20 includes logic 20D to implement, based upon the results of the context query, appropriate discovery requests with each community member 26. The discovery server 20 includes logic 20E to determine, based upon notifications from the community members 26, a list of services to be sent to the subscriber 12 as notifications of the original subscription. The discovery server 20 also includes logic 20F that reacts to changes in the set of community members 26, such as the addition or removal of resources to or from the set of community members. For this purpose the logic 20F is assumed to maintain and manage a list of community members 21. The above-referenced commonly assigned U.S. Patent Application “Content and Service Registration, Query, and Notification using SIP Event Packages”, Ser. No. 10/330,146, filed Dec. 30, 2002, provides anon-limiting example of a SIP event package that would implement a service/content availability subscription in a SIP environment.

The various logic units, functions and modules 12A, 20A-20F and 28A-28G can be constructed using hardware, software or a combination of hardware and software. In some cases the logic units, functions and modules 12A, 20A-20F and 28A-28G can be implemented in whole or in part with computer program code that is locally stored and executed by data processors that comprise the subscriber unit 12, the discovery server 20 and the context query server 28.

The community member 26 is also preferably a SIP event server, compliant with RFC 3265, that permits a subscription to available services and content. Based upon the result of the (context-dependent) discovery request, there can exist more than one community member 26. The above-referenced commonly assigned U.S. Patent Application “Content and Service Registration, Query, and Notification using SIP Event Packages”, S.N. 10/330,146, filed Dec. 30, 2002, provides a non-limiting example of a SIP event package that would allow for such availability subscription.

SIP proxies 14, 16, 22, 24 exist for the subscriber 12 as well as the various SIP event servers 20, 26, 28 (typically a different SIP proxy for each, as shown) and are responsible for the handling of SIP messages and appropriately forwarding the SIP messages to the specified entity. Note that the SIP proxies 14, 16, 22, 24 represent a non-limiting embodiment of an entity that provides forwarding of registration, subscription, and notifications, as provided by the SIP event framework specified by RFC 3265. However, other mechanisms could be used as well in other embodiments of this invention Thus, while the SIP event servers are a presently preferred embodiment, their use should not be construed as a limitation upon the implementation and practice of this invention.

This invention implements discovery requests based on requests, such as:

“Discover services among persons (resources) which are in a particular meeting, the meeting being in a particular location!”

“Discover content among persons (resources) within a certain location, the resources being present and mobile!”

“Notify me about available services within a certain location of providers that are present”

“Notify me about new content among a set of people near to my own location”

The sets of persons (resources) in abovementioned examples constitute context-based communities, or, in other words, the sets of persons (resources) constitute context-based community criteria for the discovery request.

For the SIP-based solution in the present invention, a SIP-based method is assumed to exist that allows for queries to determine a set of resources based on a certain constraint (the constraint being, in accordance with this invention, the context-based community criteria). In U.S. patent application Ser. No. 10/______, filed on even date with this patent application, and entitled “Method, System and Computer Program to Enable Querying of Resources in a Certain Context by Definition of SIP Event Package”, by Dirk Trossen and Dana Pavel, such a query method has been defined, and may used by this invention, although this invention is not constrained to use only this one particular query method.

Based upon the determination of the set of resources fulfilling the context-based community criteria, this invention issues appropriate SIP-based subscriptions to the availability of services or content to each member of the set.

Since the SIP event framework of RFC 3265 allows for notifications, the discovery supports notifications of future available services/content. The invention is also dynamic with respect to changes in the set of members in the community. Hence, if the community changes (such as by the addition or removal of a person/resource), the discovery subscriptions are appropriately adapted.

The context-related query in this invention may also support query semantic re-usage through ontologies by using content indirection methods for the subscription body, and may further support proper access control through integrating access control in the resource list determination process.

For the communication between the subscriber 12 and the discovery server 20, as well as between discovery server 20 and the community member 26, the invention defines a SIP event package, compliant with RFC 3265, having a single event designated as “service” or “content” (depending on the nature of the request), that allows for the subscription to the availability of services or content within a certain community. The body of the subscription contains the actual query for services.

In the commonly assigned “Content and Service Registration, Query, and Notification using SIP Event Packages”, Ser. No. 10/330,146, filed Dec. 30, 2002, an event package and subscription method is defined that can be employed by this invention. In addition to this functionality, the subscription for availability as employed by this invention includes context-dependent constraints, such as location, date and time, or higher level semantics that allow for constructing service queries such as:
“Services of a particular kind within a certain location”;
“Service of a particular kind provided by mobile devices that are currently present”;
“Content of a particular kind within a certain field of interest, provided by users within a certain location”.

The query is formulated using a suitable query language. The exact syntax and semantics of the query language are not germane to an understanding of this invention. However, notations such as Resource Description Format (RDF) or Extended Markup Language (XML) are suitable for use in formulating such queries.

In order to share such query semantic information among a larger set of users, i.e., to create a common knowledge of semantics, the notion of the use of the ontology server(s) is supported by the invention in the query subscription operation (as noted below).

This invention assumes the existence of an event package (a Context Query Event Package) that permits subscribing to a so-called context query. Such a query allows for subscription to a list of resources that are constrained by certain resource data, such as context information. Such resource data may reside locally on the providing SIP event server, such as the resource data 29 shown in FIG. 3, or it may be acquired by external means (for example through hierarchical SIP event subscriptions to relevant data). The exact nature of the subscription and the exact SIP event package are not within the scope of this invention. However, commonly assigned U.S. patent application Ser. No. 10/______, filed on even date with this patent application, and entitled “Method, System and Computer Program to Enable Querying of Resources in a Certain Context by Definition of SIP Event Package”, by Dirk Trossen and Dana Pavel, provides a non-limiting example of such event package that may be employed by this invention.

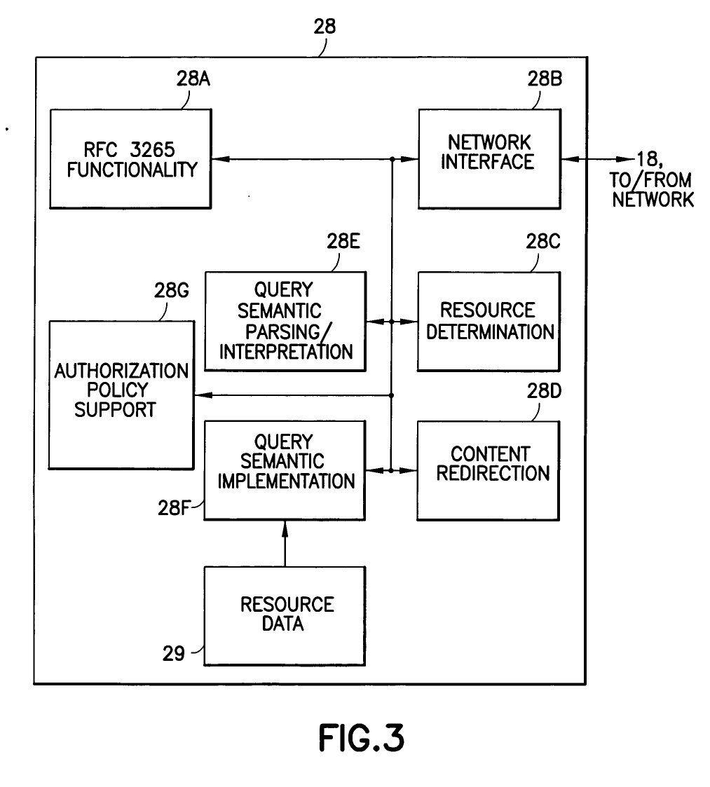

Discussed now with respect to FIG. 2 is the operation of the availability subscription, also referred to as a subscription for discovery and notification of current and future services. FIG. 2 shows the steps and messages that are used for the subscription to the availability of services or content, dependent on certain context information. For the sake of simplification, FIG. 2 omits the routing of messages via the SIP proxies 14, 16, 22, 24, and the exchange of SIP messages is shown directly between the SIP servers 20, 26, 28 and the subscriber 12 entities.

Compliant with RFC 3265 the subscriber 12 sends a SIP SUBSCRIBE (message 1 in FIG. 2) to the discovery server 20. The SUBSCRIBE message header includes an appropriate event package identifier for a discovery event package. Upon reception of the subscription message (message 1 in FIG. 2), the discovery server 20 extracts the message body and parses the included semantic information of the discovery query. If the discovery query can be supported by the discovery server 20 (that is, the semantic is supported locally, or if an appropriate context query server 28 is available to fulfil the request), the discovery server 20 confirms the subscription with a ‘200 OK’ message (message 2 in FIG. 2), compliant with RFC 3265.

The context-related information in the original subscription body of message 1 in FIG. 2 is used to formulate a context query event subscription to the context query server 28 (sent as message 3 in FIG. 2). With such a mechanism, the discovery server 20 is enabled to formulate context-dependent queries to the context query server 28 such as:
“Which resources/persons are within a certain location?”
“Which resources/persons are within a certain meeting and present?”

Note that the context query subscription can also contain information such as user preferences (e.g., likes and dislikes), user information (e.g., field of expertise) or other semantic information to be used in formulating a set of constraints.

The context query server 28 responds to the subscription with a ‘200 OK’ (message 4 in FIG. 2) if the query semantic (which was included in the subscription message) has been understood. If the subscription cannot be granted, the context query server 28 returns an appropriate error code, compliant with RFC 3265, which results in terminating the subscription at the discovery server 20.

It should be noted that the context query server 28 may use one or more of the above-noted-ontology servers for re-using and sharing semantic definition among several subscribers, and that the message body may include links to such ontology servers. Content indirection methods, such as the one described by S. Olson, “Requirements for Content Indirection in Session Initiation Protocol”, IETF Draft, September 2002, can be used to retrieve the semantic information from the specified ontology server. The retrieved information is then parsed by the context query server 28 as if given directly in the message body.

Assuming that the subscription is granted, the context query subscription is used within the context query server 28 to determine the initial set of resource URIs that would fulfil the constraints of the context query. The initial set of resource URIs is returned to the discovery server 20 within an initial SIP NOTIFY (compliant with RFC 3265), sent as message 5 in FIG. 2. The determined set of resource URIs constitutes the initial set of community members 26 in FIG. 1.

Upon reception of the initial set of resource URIs (assuming that this set of resource URIs is non-empty, otherwise the following messages 6 to 8 are skipped), the discovery server 20 subscribes to the availability of service/content at each community member 26. For this purpose the discovery server 20 sends a SIP SUBSCRIBE to each community member 26 for an availability event (shown as message 6 in FIG. 2). The message body contains the service/content-specific part of the original discovery subscription message sent by the subscriber 12 (i.e., message 1 in FIG. 2). If the community member 26 supports the subscription (and grants the subscription based on authorization policies), the community member 26 responds with a ‘200 OK’ (compliant with RFC 3265), sent as message 7 in FIG. 2. The community member 26 further responds with a SIP NOTIFY, containing the initial set of services that match the provided service requirements of the subscription, sent as message 8 in FIG. 2.

Upon reception of all answers of all current community members 26 (either upon reception of initial SIP NOTIFYs. or reception of error codes in those cases where the subscription cannot be granted), the discovery server 20 formulates an initial SIP NOTIFY, containing the accumulated set of services that was discovered, and sends it to the subscriber 12 as message 9 in FIG. 2.

As a result of these operations it can be appreciated that the subscriber 12 has obtained the current set of services available at all community members 26 at this point in time, and the community is built based on the context information given in the original subscription request of the subscriber 12.

In the case where the lifetime of the subscription request in message 1 indicates a value of zero, the subscription terminates after the initial NOTIFY (message 9 in FIG. 2), compliant with RFC 3265. Hence, the subscription request of message 1 actually functions as a community-based service discovery request.

In the case where the lifetime of the original subscription request indicates a non-zero value, two different notifications may occur in the future.

An availability notification may occur if a service or content, that would fit the availability subscription (message 6 in FIG. 2) becomes available at the community member 26. In this case the community member 26 generates a SIP NOTIFY message and sends it as message 10 to the discovery server 20. Upon reception of this notification the discovery server 20 sends a SIP NOTIFY (message 11 in FIG. 2), for the subscription dialog generated with message 1, to the subscriber 12. The body of this notification contains information descriptive of the service/content and the community member 26, so that the subscriber 12 can contact the community member 26 for service/content provisioning purposes.

A community change notification occurs if the set of community members changes. This change may occur due to changes in context information relating to the community members 26. For example, if the community was built upon, among other information, location information, a change in the location (such as leaving the location) of a community member 26 may lead to a removal from the set of community members 26. Or, as a further non-limiting example, a change in the location of a resource URI may lead to an addition to the set of community members (such as by having the resource URI enter a particular location, such as entering the relevant community in the case where other constraints match).

In the change case the context query server 28 generates a SIP NOTIFY message (message 12 in FIG. 2) that contains the updated set of community members 26. If the new community member set indicates a removal of a former member, the discovery server 20, specifically the logic 20F, removes this community member from the internal list 21 so as to avoid availability notifications being sent to the subscriber 12 from non-members of the community. If the new community member set indicates the addition of a member, the discovery server 20 initiates a subscription for available services/content, similar to the message sequence 6 to 9 above. Hence, the discovery server 20 sends a SIP SUBSCRIBE to each new community member 26 for an availability event (shown as message 13 in FIG. 2). The message body contains the service/content-specific part of the original discovery subscription message sent by the subscriber 12 (message 1 in FIG. 2). If the community member 26 supports the subscription, and grants the subscription based on authorization policies, the community member 26 responds with a ‘200 OK’ (compliant with RFC 3265), that is sent as message 14 in FIG. 2. The community member 26 further responds with a SIP NOTIFY, containing the initial set of services that match the provided service requirements of the subscription, sent as message 15 in FIG. 2. Upon reception of all answers of all new community members 26 (either upon reception of the initial SIP NOTIFYs, or the reception of error codes in those cases where the subscription cannot be granted), the discovery server 20 formulates a SIP NOTIFY, containing the accumulated set of services that were discovered, and sends it to the subscriber 12 as message 16 in FIG. 2.

It can be appreciated that one advantage that arises by the use of this invention is the enablement of discovery requests within a certain community of interest, where the community is built, at least partially, based upon context information, in a SIP-based environment. Further, the multi-component discovery request is realized within a single subscription dialog, thereby improving the scalability of the invention. The invention also allows for notifications about services/content that become available in the future, and is further dynamic with respect to community changes, for example, upon the removal or the addition of community members 26, as the discovery subscriptions are re-organized.

The invention may also enable semantic re-usage through ontology support, and may further integrate access right solutions, such as the current XCAP method, in the determination of the query answer. That is, the method preserves the integrity of currently developed privacy frameworks for SIP events.

Another advantage of the use of this invention is the control of complexity at the context query server 28. Although the queries for resource lists can become complex, it is the decision of the context query server 28 as to whether a given subscription is granted. Hence, if the additional subscription dialog would overburden the context query server 28 due to its complexity, the subscription can simply be rejected.

To support the foregoing functionality the context query server 28 is enhanced relative to conventional servers to provide additional query parsing and data mining or analysis functionality. Note that the data mining/analysis functionality occurs on a set of existing data, as there is no additional data that is required to be gathered from other supported event packages. If one or both of the query parsing and data mining/analysis functionalities are not supported by the context query server 28, the context query server 28 can simply reject the discovery event package. Hence, this invention provides a modular, scalable and expandable solution, that simplifies the deployment of such query support in a network of SIP event servers.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent message type and formats, resources and network architectures, may be attempted by those skilled in the art. Furthermore, it should be appreciated that in come embodiments all or some of the functionality of the discovery server 20 and the context query server 28 may be combined in one SIP event server. In this case any messages sent between the discovery server and the context query server, such as the messages 3, 4, 5 and 12 in FIG. 2, may be internal messages (i.e., internal to the server that hosts both the discovery and the context query functions). However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

1. A method to operate an event notification system comprising servers and a subscriber unit, comprising:
sending a subscription request message from the subscriber unit to a discovery server, the subscription request message comprising a discovery query;
responsive to a receipt of the subscription request message, parsing the discovery query;
accepting the subscription request if the discovery query is supportable by the discovery server;
formulating a context query based on the parsed discovery query;
sending the context query to a context query server; and
parsing the context query and returning in response identifications of a plurality of event servers forming a community of event servers that together determine a result of the discovery query.

2. A method as in claim 1, further comprising using the discovery server to subscribe to the availability of each of the event servers that form the community of event servers, and notifying the subscriber unit of available services that are discovered.

3. A method as in claim 2, where for a case where a lifetime of the subscription request message is non-zero the method further comprises notifying the subscriber unit of a change in availability of a previously unavailable service provided by an event server of the community of event servers.

4. A method as in claim 2, where for a case where a lifetime of the subscription request message is non-zero the method further comprises notifying the subscriber unit of a change in membership of the community of event servers.

5. A method as in claim 4, further comprising updating a list of event servers that form the community of event servers, the list being maintained by the discovery server.

6. A method as in claim 1, where parsing the context query includes referring to an ontology server using a content indirection technique.

7. A method as in claim 1, where parsing the context query includes consulting a local source of resource data, and determining if event servers representing resources needed to determine the result of the discovery query are available.

8. A method as in claim 1, where parsing the context query includes consulting an authorization policy for at least some of the resource data needed to determine the result of the discovery query.

9. A method as in claim 1, where the event servers each comprise a Session Initiation Protocol (SIP) event server.

10. A method as in claim 9, where sending the subscription request message and sending the context query occurs through at least one SIP proxy.

11. A method as in claim 1, where the subscriber unit is associated with a mobile wireless communications device.

12. A method as in claim 1, where the discovery query comprises context-dependent constraints.

13. A method as in claim 12, where resource data associated with the context-dependent constraints is comprised of at least some of presence data, watcherinfo, call state and application-specific events.

14. A method as in claim 1, where the discovery query comprises user-related information, including user preferences.

15. An event notification system comprising servers and a subscriber unit coupled to a data communications network, said subscriber unit operable to send a subscription request message to a discovery server, the subscription request message comprising a discovery query; said discovery server comprising logic, responsive to a receipt of the subscription request message, to parse the discovery query and to accept the subscription request if the discovery query is supportable by the discovery server and to formulate a context query based on the parsed discovery query and to send the context query to a context query server; and said context query server comprising logic to parse the context query and return in response identifications of a plurality of event servers forming a community of event servers that together determine a result of the discovery query.

16. An event notification system as in claim 15, further comprising additional logic at said discovery server to subscribe to the availability of each of the event servers that form the community of event servers, and to notify the subscriber unit of available services that are discovered.

17. An event notification system as in claim 16, where for a case where a lifetime of the subscription request message is non-zero said discovery server logic notifies the subscriber unit of a change in availability of a previously unavailable service that is provided by an event server of the community of event servers.

18. An event notification system as in claim 16, where for a case where a lifetime of the subscription request message is non-zero said discovery server logic notifies the subscriber unit of a change in membership of the community of event servers.

19. An event notification system as in claim 18, where said discovery server logic updates a list of event servers that form the community of event servers, the list being maintained by the discovery server.

20. An event notification system as in claim 15, where said context query server when parsing the context query queries an ontology server using a content indirection technique.

21. An event notification system as in claim 15, where said context query server when parsing the context query consults a local source of resource data, and determines if event servers representing resources needed to determine the result of the discovery query are available.

22. An event notification system as in claim 15, where said context query server when parsing the context query consults an authorization policy for at least some of the resource data needed to determine the result of the discovery query.

23. An event notification system as in claim 15, where said event servers each comprise a Session Initiation Protocol (SIP) event server.

24. An event notification system as in claim 23, where said SIP event servers, and said subscriber unit, are coupled to said data communications network via at least one SIP proxy.

25. An event notification system as in claim 15, where said subscriber unit comprises a mobile wireless communications device.

26. An event notification system as in claim 15, where said discovery query comprises context-dependent constraints.

27. An event notification system as in claim 26, where the resource data associated with the context-dependent constraints is comprised of at least some of presence data, watcherinfo, call state and application-specific events.

28. An event notification system as in claim 15, where said discovery query comprises user-related information, including user preferences.

29. A subscriber unit operable in an event notification system comprising servers coupled to a data communications network, said subscriber unit comprising logic for sending a subscription request message to a discovery server, the subscription request message comprising a discovery query; said subscriber unit being further responsive to receive a notification of available services that are discovered comprising identifications of a plurality of event servers forming a community of event servers that together determine a result of the discovery query

30. A subscriber unit as in claim 29, where for a case where a lifetime of the subscription request message is non-zero said subscriber unit is responsive to notification of a change in availability of a previously unavailable service that is provided by an event server of the community of event servers.

31. A subscriber unit as in claim 29, where for a case where a lifetime of the subscription request message is non-zero said subscriber unit is responsive to notification of a change in membership of the community of event servers.

32. A subscriber unit as in claim 29, where said event servers each comprise a Session Initiation Protocol (SIP) event server, and where said subscriber unit comprises a mobile wireless communications device.

33. A discovery server operable in an event notification system comprising servers and a subscriber unit coupled to a data communications network, said discovery server comprising logic responsive to a receipt of a subscription request message from the subscriber unit, the subscription request message comprising a discovery query, to parse the discovery query and to accept the subscription request if the discovery query is supportable by the discovery server and to formulate a context query based on the parsed discovery query and to send the context query to a context query server, and to receive in response identifications of a plurality of event servers forming a community of event servers that together determine a result of the discovery query.

34. A discovery server as in claim 33, further comprising logic to subscribe to the availability of each of the event servers that form the community of event servers, and to notify the subscriber unit of available services that are discovered.

35. A discovery server as in claim 34, where for a case where a lifetime of the subscription request message is non-zero said discovery server logic notifies the subscriber unit of a change in availability of a previously unavailable service that is provided by an event server of the community of event servers.

36. A discovery server as in claim 34, where for a case where a lifetime of the subscription request message is non-zero said discovery server logic notifies the subscriber unit of a change in membership of the community of event servers.

37. A discovery server as in claim 36, where said discovery server logic updates a list of event servers that form the community of event servers, the list being maintained by the discovery server.

38. A discovery server as in claim 33, where said discovery server comprises a Session Initiation Protocol (SIP) event server, and where said subscriber unit comprises a mobile wireless communications device.

39. A context query server operable in an event notification system comprising servers and a subscriber unit coupled to a data communications network, said context query server comprising logic responsive to receipt of a context query derived from a discovery query initiated by said subscriber unit to parse the context query and return in response identifications of a plurality of event servers forming a community of event servers that together determine a result of the discovery query.

40. A context query server as in claim 39, where said context query server when parsing the context query queries an ontology server using a content indirection technique.

41. A context query server as in claim 39, where said context query server when parsing the context query consults a local source of resource data, and determines if event servers representing resources needed to determine the result of the discovery query are available.

42. A context query server as in claim 39, where said context query server when parsing the context query consults an authorization policy for at least some of the resource data needed to determine the result of the discovery query.

43. A context query server as in claim 39, where said context query server comprises a Session Initiation Protocol (SIP) event server, and where said subscriber unit comprises a mobile wireless communications device.

44. A computer program product embodied on a computer readable medium for directing a data processor of a subscriber unit to operate in an event notification system comprising servers coupled to a data communications network by operations that comprise:
sending a subscription request message to a discovery server, the subscription request message comprising a discovery query; and
receiving a notification of available services that are discovered comprising identifications of a plurality of event servers forming a community of event servers that together determine a result of the discovery query

45. A computer program product as in claim 44, where for a case where a lifetime of the subscription request message is non-zero, being responsive to notification of a change in availability of a previously unavailable service that is provided by an event server of the community of event servers.

46. A computer program product as in claim 44, where for a case where a lifetime of the subscription request message is non-zero, being responsive to notification of a change in membership of the community of event servers.

47. A computer program product as in claim 44, where said event servers each comprise a Session Initiation Protocol (SIP) event server, and where said subscriber unit comprises a mobile wireless communications device.

48. A computer program product embodied on a computer readable medium for directing a data processor of a discovery server to operate in an event notification system comprising servers and a subscriber unit coupled to a data communications network by operations comprising:
responsive to a receipt of a subscription request message from the subscriber unit, the subscription request message comprising a discovery query, parsing the discovery query;
accepting the subscription request if the discovery query is supportable by the discovery server;
formulating a context query based on the parsed discovery query;
sending the context query to a context query server; and
receiving in response identifications of a plurality of event servers forming a community of event servers that together determine a result of the discovery query.

49. A computer program product as in claim 48, further comprising an operation of subscribing to the availability of each of the event servers that form the community of event servers, and notifying the subscriber unit of available services that are discovered.

50. A computer program product as in claim 49, where for a case where a lifetime of the subscription request message is non-zero, further comprising an operation of notifying the subscriber unit of a change in availability of a previously unavailable service that is provided by an event server of the community of event servers.

51. A computer program product as in claim 49, where for a case where a lifetime of the subscription request message is non-zero, further comprising an operation of notifying the subscriber unit of a change in membership of the community of event servers.

52. A computer program product as in claim 51, further comprising an operation of updating a list of event servers that form the community of event servers, the list being maintained by the discovery server.

53. A computer program product as in claim 48, where said discovery server comprises a Session Initiation Protocol (SIP) event server, and where said subscriber unit comprises a mobile wireless communications device.

54. A computer program product embodied on a computer readable medium for directing a data processor of a context query server to operate in an event notification system comprising servers and a subscriber unit coupled to a data communications network by operations comprising:
responsive to receipt of a context query derived from a discovery query initiated by said subscriber unit, parsing the context query; and
returning in response identifications of a plurality of event servers forming a community of event servers that together determine a result of the discovery query.

55. A computer program product as in claim 54, where parsing the context query further comprises an operation of querying an ontology server using a content indirection technique.

56. A computer program product as in claim 54, where parsing the context query further comprises an operation of consulting a local source of resource data, and determining if event servers representing resources needed to determine the result of the discovery query are available.

57. A computer program product as in claim 54, where parsing the context query further comprises an operation of consulting an authorization policy for at least some of the resource data needed to determine the result of the discovery query.

58. A computer program product as in claim 54, where said context query server comprises a Session Initiation Protocol (SIP) event server, and where said subscriber unit comprises a mobile wireless communications device.
